(19) United States
(12) Patent Application Publication
(10) Pub. No.: US 2007/0094612 A1
(43) Pub. Date: Apr. 26, 2007

(54) Method, a device and a computer program product for dynamically positioning of a pop-up window

(75) Inventors: Christian Kraft, Frederiksberg C (DK); Peter Nielsen, Lyngby (DK); Tomi Heinonen, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/258,597

(22) Filed: Oct. 24, 2005

(51) Int. Cl. G06F 9/00

(52) U.S. Cl. 715/808

(57) ABSTRACT

A method, a device and a computer program product are shown for positioning of a pop-up window in a display of a mobile terminal device. In particular, the present invention relates to method, device and computer program product for dynamically positioning of the pop-up window in the display of the mobile terminal device.

### FIELD OF THE INVENTION

The present invention relates to a method, a device and a computer program product for positioning of a pop-up window. In particularly, the present invention relates to a method, a device and a computer program product for dynamically positioning of a pop-up window in a display of a mobile terminal device.

### BACKGROUND OF THE INVENTION

Pop-up windows have become very popular in the field of computer- and IT-technology as they can deliver user-relevant messages at a certain moment of time. Thereby, said pop-up window or said pop-up windows are positioned at a certain position on the display of a terminal device, whereby often relevant sections of the display are overlapped and the user cannot any longer see what is arranged below the pop-up window, especially when the user uses a mobile TV phone and is watching TV.

Such pop-up windows according to the state of the art are often arranged on a display of a mobile terminal device by the TV-producers and there is no computer program product involved, which automatically can determine which would be the best place for a dynamically positioning of a pop-up window, when an incoming event, e.g. a certain message, is received. Therefore, e.g. the TV-program always has to be observed by the TV-producer producer such as to position said pop-up window at an adequate position and not to disturb the user while watching TV for example.

It would be therefore suitable to provide a method, a mobile terminal device and a computer program product such as to make such a handling of pop-up windows, which contain certain messages as easy as possible.

Therefore, the present invention aims to deliver a method, a computer program product and a mobile terminal device, which allow to dynamically positioning one or several pop-up windows on a display of an electronic device.

The present invention especially aims to deliver a method, computer program product and a mobile terminal device, which allow a dynamical positioning of one or several pop-up windows on a display of a mobile terminal device.

### SUMMARY OF THE INVENTION

An overall object of the present invention is to provide a method, a computer program product and a mobile terminal device to provide a user a dynamically positioning of a pop-up window in a display of a mobile terminal device.

The objects of the present invention are solved by the subject matter defined in the accompanying independent claims.

According to a first aspect of the present invention a method for dynamically positioning of a pop-up window in a display of a mobile terminal device is provided, said display showing changing pixels, wherein said mobile terminal device is detecting an event to trigger appearance of said pop-up window on said display, wherein said method is comprising:
analyzing a content of said display; and
determining a suitable area for said pop-up window, where said pop-up window can be positioned with minimum interference with said content.

This has the advantage that it is possible to make automatically a dynamically positioning of a pop-up window in a display of a mobile terminal device.

According to a further embodiment of the present invention said mobile terminal device is detecting an event to trigger appearance of said pop-up window on said display, wherein there is conducted an analyzing step to determine an area characterized by at least one of the following features:
the smallest amount of changing pixels for a predetermined period of time; and/or
a minimum of difference in colour and/or intensity between the pixels of said area; and/or
a specific shaped structure of a human body which is stationary for a predetermined period of time.
subtitles/text.

This has the advantage that with said method it is possible to control a dynamical appearance of pop-up windows on a display of a mobile terminal device.

According to a further embodiment of the present invention said pop-up window is displayed for a certain period of time in said determined area after said detection. This has the advantage that said method is user-configurable.

According to a further embodiment of the present invention said pop-up window is displayed transparent. This has the advantage that said pop-up window is interfering said content of said display only minimally.

According to a further embodiment of the present invention said analyzing step is repeated in case the area in which the pop-up window is placed is affected by changing pixels. This has the advantage that said method optimizes an appearance of pop-up windows on said display, such that relevant areas of a display are not covered by a pop-up window and so the user is not interrupted by appearing pop-up windows.

According to a further embodiment of the present invention a size of said pop-up window is related to the size of said determined area and changes dynamically therewith. This has the advantage that said method optimizes an appearing of pop-up windows on said display, such that relevant areas of a display are not covered by a pop-up window and so the user is not interrupted by appearing pop-up windows.

According to a further embodiment of the present invention a position of said pop-up window is dependent on a position of said determined area and dynamically changes therewith. This has the advantage that said method optimizes an appearing of pop-up windows on said display, such that relevant areas of a display are not covered by a pop-up window and so the user is not interrupted by appearing pop-up windows.

According to a further embodiment of the present invention said pop-up window does a rotational, translational or any randomly generated movement on said display. This has the advantage that said method optimizes an appearing of pop-up windows on said display, such that relevant areas of a display are not covered by a pop-up window and so the user is not interrupted by appearing pop-up windows.

According to a further embodiment of the present invention said event is a receipt of a message. This has the advantage that the user is provided with user-specific messages, like SMS, e-mail, etc.

According to a further embodiment of the present invention a first pop-up window appears on said display upon triggering receipt of a message and whereby a further pop-up window appears on said display when a further message is received by said mobile terminal device. This has the advantage that several messages can be received by said mobile terminal device.

According to a further embodiment of the present invention said pop-up window is removed from said display after a predetermined amount of time has elapsed or a user input is received. This has the advantage that the method of the present invention is user-configurable.

According to a further embodiment of the present invention said pop-up window is keeping its originally determined position until the user selects a new user-configurable position of said pop-up window on said display. This has the advantage that the method of the present invention is user-configurable.

According to a further embodiment of the present invention said pop-up window keeps its position on said display, when the mobile terminal device is switched off. This has the advantage that the pop-up window keeps the same position, especially when a film is interrupted and wants to started again at the same sequence.

According to a further embodiment of the present invention said pop-up window keeps its position and still is visible on said display, when the display is switched off. This has the advantage that the user can read the message shown by the pop-up window, even if he/she has forgotten to do so before switching off said mobile terminal device.

According to a further embodiment of the present invention said pop-up window appears for the first time on said display, when the mobile terminal device is switched on, a specific sound is actuated, said sound being user-configurable. This has the advantage that the method is user-configurable and informs said user of incoming messages.

According to a further embodiment of the present invention said user can switch on or off said method, when the mobile terminal device is operating. This has the advantage that the method according to the present invention is user-configurable.

According to a further embodiment of the present invention said smallest amount of changing pixels is determined by analysing of pixels on said display. This has the advantage that the method of the present invention optimizes said dynamically positioning of pop-up windows on said display.

According to a further embodiment of the present invention said mobile terminal device is a mobile TV phone. This has the advantage that said method can be used everywhere the user moves and therefore the user can receive messages at different places while watching TV.

According to a further embodiment of the present invention said pop-up window is positioned in an area on the display on the top of subtitles/text, whereby said pop-up window does not cover said subtitles/text. This has the advantage that the method of the present invention optimizes said dynamically positioning of pop-up windows on said display.

According to a further embodiment of the present invention a position of subtitles/text is recognized by a DVB-H software. This has the advantage that the method of the present invention optimizes said dynamically positioning of pop-up windows on said display.

According to a further embodiment of the present invention said DVB-H software will input corresponding information for a pop-up software, if subtitles/text are rendered in said DVB-H software. This has the advantage that the method of the present invention optimizes said dynamically positioning of pop-up windows on said display.

According to a further embodiment of the present invention said DVB-H software or some other software analyzes video frames. This has the advantage that the method of the present invention optimizes said dynamically positioning of pop-up windows on said display.

According to a further embodiment of the present invention spatial high-frequency intensities are analysed by said DVB-H software or some other software. This has the advantage that the method of the present invention optimizes said dynamically positioning of pop-up windows on said display.

According to a further embodiment of the present invention corresponding information is input to a pop-up software after spatial high-frequency intensities with straight shapes are analysed. This has the advantage that the method of the present invention optimizes said dynamically positioning of pop-up windows on said display.

According to a further embodiment of the present invention said information is processed in a video decoder. This has the advantage that the method of the present invention optimizes said dynamically positioning of pop-up windows on said display.

According to a further embodiment of the present invention said information is processed in a video codec. This has the advantage that the method of the present invention optimizes said dynamically positioning of pop-up windows on said display.

According to a further embodiment of the present invention said subtitles/text are recognized by said DVB-H software. This has the advantage that the method of the present invention optimizes said dynamically positioning of pop-up windows on said display.

According to a further embodiment of the present invention said subtitles/text are dynamic or fixed on said display. This has the advantage that said method can by used in a wide field of application.

According to a further embodiment of the present invention said DVB-H software or some other software analyzes video frames to find textual content if said subtitles/text are fixed.

This has the advantage that the method of the present invention optimizes said dynamically positioning of pop-up windows on said display.

According to a further embodiment of the present invention said video decoder is used for determining the location of said pop-up window on said display. This has the advantage that said method can by used in a wide field of application.

According to a further embodiment of the present invention said method uses motion vectors for macro-blocks. This has the advantage that the method of the present invention optimizes said dynamically positioning of pop-up windows on said display.

According to a further embodiment of the present invention with said motion vectors it is possible to estimate which, e.g., 16×16 blocks of a video content on said display have moved and in which direction. This has the advantage that the method of the present invention optimizes said dynamically positioning of pop-up windows on said display.

According to a further embodiment of the present invention said pop-up window is covering said portion which is strongly changing, wherein said fixed portion is not covered, if a portion of said video frames is fixed and a background on said display is changing. This has the advantage that the method of the present invention optimizes said dynamically positioning of pop-up windows on said display.

According to a further embodiment of the present invention said pop-up window covers said portion which is fixed, if a small portion of said video frame is changing while the rest of the frame is almost fixed. This has the advantage that the method of the present invention optimizes said dynamically positioning of pop-up windows on said display.

According to a further embodiment of the present invention video frames are updated by a window server. This has the advantage that the method of the present invention optimizes said dynamically positioning of pop-up windows on said display.

According to a further embodiment of the present invention said video frames are updated by a display driver. This has the advantage that the method of the present invention optimizes said dynamically positioning of pop-up windows on said display.

According to a further embodiment of the present invention said pop-up window is displayed partly transparent. This has the advantage that the method of the present invention optimizes said dynamically positioning of pop-up windows on said display.

According to a further embodiment of the present invention said changing pixels are changing pixels of a displayed DVB-H stream. This has the advantage that the method of the present invention optimizes said dynamically positioning of pop-up windows on said display.

According to a further embodiment of the present invention said analyzing of face shaped structures in said changing pixels is executed by an algorithm. This has the advantage that the method of the present invention optimizes said dynamically positioning of pop-up windows on said display.

According to a further embodiment of the present invention an algorithm is analyzing face shaped structures in said changing pixels. This has the advantage that the method of the present invention optimizes said dynamically positioning of pop-up windows on said display.

According to a further embodiment of the present invention an algorithm is analyzing face shaped structures in said changing pixels. This has the advantage that the method of the present invention optimizes said dynamically positioning of pop-up windows on said display.

According to another aspect of the present invention a computer program product is provided, wherein said computer product comprises program code sections for carrying out operations, when said program is run on a processor-based device, a terminal device, a mobile terminal device, a network device, a portable terminal device, a consumer electronic device, or a mobile communication enabled terminal device, wherein a method for dynamically positioning of a pop-up window in a display of a mobile terminal device is used, said display showing changing pixels, wherein said mobile terminal device is detecting an event to trigger appearance of said pop-up window on said display, wherein said method is comprising:
analyzing the content of said display; and
determining a suitable area for said pop-up window, where said pop-up window can be positioned with minimum interference with said content.

This has the advantage that with said computer program product said method of the present invention is optimized for said dynamically positioning of pop-up windows on said display.

According to another aspect of the present invention said computer program product comprises program code sections, which are stored on a machine-readable medium. This has the advantage that with said computer program product said method of the present invention is optimized for said dynamically positioning of pop-up windows on said display.

According to a further aspect of the present invention a mobile terminal device for dynamically positioning of a pop-up window in a display of a mobile terminal device is provided, wherein said mobile terminal device comprises a display and a CPU-module and wherein said display is showing pixels, wherein said mobile terminal device is detecting an event to trigger appearance of said pop-up window on said display, comprising:
a module for analyzing the content of said display; and
a module for determining a suitable area for said pop-up window, where said pop-up window can be positioned.

This has the advantage that said method of the present invention, which is optimized for said dynamically positioning of pop-up windows on said display, is used in said mobile terminal device which allows a wide field applications in computer- and IT-technology.

According to a further embodiment of the present invention a mobile terminal device for dynamically positioning of a pop-up window in a display of a mobile terminal device is provided, wherein a module for analyzing is configured for analyzing an area on said display, said area having
the smallest amount of changing pixels of said area for a predetermined period of time; and/or
a minimum of difference in colour and/or intensity between the pixels of said area; and/or
a specific part of a human body for a predetermined period of time; and/or
subtitles/text/text; and said CPU-module being configured for
displaying said pop-up window in said analyzed area on said display.

This has the advantage that said method of the present invention, which is optimized for said dynamically positioning of pop-up windows on said display, is used in said mobile terminal device which allows a wide field applications in computer- and IT-technology.

According to a further embodiment of the present invention said device is a mobile TV phone. This has the advantage that said method of the present invention, which is optimized for said dynamically positioning of pop-up windows on said display, is used in said mobile terminal device which allows a wide field applications in computer- and IT-technology.

According to a further embodiment of the present invention said device comprises a video decoder, which is connected to said CPU-module and said display and wherein said video decoder being configured for determining the location of said pop-up window on said display. This has the advantage that said method of the present invention, which is optimized for said dynamically positioning of pop-up windows on said display, is used in said mobile terminal device which allows a wide field applications in computer- and IT-technology.

According to a further embodiment of the present invention said device comprises a window server, which is connected to said CPU-module and said display and wherein said window server being configured for updating video frames. This has the advantage that said method of the present invention, which is optimized for said dynamically positioning of pop-up windows on said display, is used in said mobile terminal device which allows a wide field applications in computer- and IT-technology.

According to a further embodiment of the present invention said device comprises a display driver, which is connected to said CPU-module and said display and wherein said display driver being configured for updating video frames. This has the advantage that said method of the present invention, which is optimized for said dynamically positioning of pop-up windows on said display, is used in said mobile terminal device which allows a wide field applications in computer- and IT-technology.

Advantages of the present invention will become apparent to the reader of the present invention when reading the detailed description referring to embodiments of the present invention, based on which the inventive concept is easily understandable.

Throughout the detailed description and the accompanying drawings same or similar components, units or devices will be referenced by same reference numerals for clarity purposes.

### BRIEF DESCRIPTION OF THE DRAWINGS

The accompanying drawings are included to provide a further understanding of the invention and are incorporated in and constitute a part of this specification. The drawings illustrate embodiments of the present invention and together with the description serve to explain the principles of the invention. In the drawings,

FIG. 1 illustrates a block diagram of the methodical steps for a dynamically positioning of a pop-up window on a display of a mobile terminal device.

FIG. 2 illustrates a block diagram of the methodical steps for a dynamically positioning of a pop-up window, wherein analyzing steps are given in detail.

FIG. 3 illustrates a block diagram of the methodical steps for a dynamically positioning of a pop-up window for a certain period of time.

FIG. 4 illustrates a block diagram of the methodical steps for a dynamically positioning of a pop-up window, wherein an analyzing of an area is repeated.

FIG. 5 illustrates a part of a block diagram of the methodical steps for a dynamically positioning of a pop-up window, wherein it is shown, which movements a pop-up window can do on said display.

FIG. 6 illustrates a block diagram of the methodical steps for a dynamically positioning of a pop-up window, wherein e.g. a second event is determined by said mobile terminal device.

FIG. 7 illustrates a block diagram of the methodical steps for a dynamically positioning of a pop-up window, wherein said pop-up window is displayed in said determined area until a user input is received.

FIG. 8 illustrates a block diagram of the methodical steps for a dynamically positioning of a pop-up window, until a new user-configurable position is selected by said user.

FIG. 9 illustrates a block diagram of the methodical steps for a dynamically positioning of a pop-up window, wherein in steps S108 to S110 it is shown how a pop-up window can be displayed in said determined area.

FIG. 10 illustrates a block diagram of the methodical steps for a dynamically positioning of a pop-up window, wherein said smallest amount of changing pixels is determined by analysing of pixels.

FIG. 11 illustrates a diagram of a computer program product, which runs on a processor-based device and which comprises program codes for carrying out operations according to said method of the present invention.

FIG. 12 illustrates a diagram of a mobile terminal device for a dynamically positioning of a pop-up window, wherein details of said method are shown and whereby a pop-up window is shown on said display.

FIG. 13 illustrates a diagram of a mobile terminal device for a dynamically positioning of a pop-up window, wherein details of said method are shown and whereby a pop-up window is shown on said display.

### DETAILED DESCRIPTION OF THE DRAWINGS

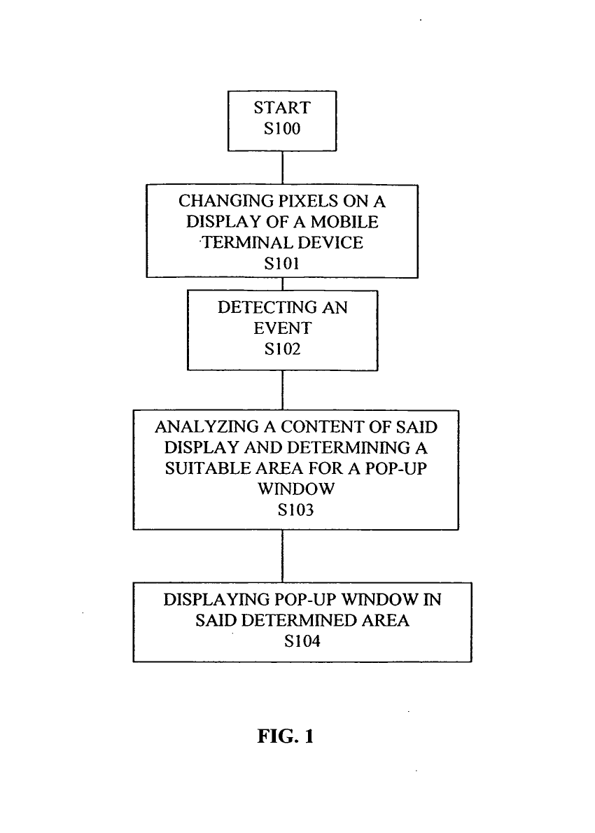

With reference to FIG. 1 it is illustrated a block diagram of the methodical steps for a dynamically positioning of a pop-up window 10 on a display 200 of a mobile terminal device 100.

Thereby the methodical steps for a dynamically positioning of a pop-up window 10 in a display 200 of a mobile terminal device 100 are shown, said display 200 showing changing pixels of a film, a animated graphics or an otherwise changing pixel application, wherein said mobile terminal device 100 is detecting an event to trigger appearance of said pop-up window 10 on said display 200, wherein said method is comprising: analyzing a content of said display; and determining a suitable area for said pop-up window, where said pop-up window 10 can be positioned with minimum interference with said content.

In step S100 the mobile terminal device 100 is started by a user, so the user is switching on said mobile terminal device 100. The mobile terminal device 100 can be a mobile TV phone. So the user can watch TV and also receive or execute calls.

While the mobile terminal device 100 is operative and a user is watching TV or something other on said display 200 of said mobile terminal device 100 there are changing pixels associated with a film, an application or animated features on said display 200 of said mobile terminal device 100, as during e.g. a film the pixels change their colour and/or intensity.

In a further step S102 said mobile terminal device 100 is detecting an event 102. Said event can be an incoming message, e.g. a SMS, a message that said user received an e-mail, etc. In a further step S103 in said method an area is determined, by analyzing a content of said display 10. Thereby a suitable area is determined for said pop-up window, where said pop-up window can be positioned with minimum interference with said content. This can be done by monitoring and changing pixels and analyzing the amount of change.

Finally after one or more areas, which do not interfere with said content of said display, are determined a pop-up window 10 with said message is displayed in said determined one ore more areas in step S104.

Further it is noted that the size of said pop-up window 10 is related to the size of said determined area and changes dynamically therewith. Also the position of said pop-up window 10 is dependent on a position of said determined area and dynamically changes therewith.

Said event is a receipt of a message, e.g. in form of a SMS, an e-mail or any other message in electronic form. It is also possible that a second, third, etc. pop-up window 10 appears on said display 200 upon triggering receipt of a message and whereby a further pop-up window 10 appears on said display 200 when a further message is received by said mobile terminal device 100.

Further it is also conceivable that after said pop-up window 10 appears for the first time on said display 200, when the mobile terminal device 100 is switched on, a specific sound is actuated, said sound being user-configurable.

Further said user can switch on or off said described method according to the invention, when the mobile terminal device 100 is operating.

Further has to be noted that said pop-up window 10 is positioned in an area on the display 200 on the top of subtitles/text, whereby said pop-up window 10 does not cover said subtitles/text. Thereby a position of subtitles/text is recognized by a DVB-H software and said DVB-H software will input corresponding information for a pop-up software if subtitles/text are rendered in said DVB-H software.

In the method of the present invention said DVB-H software or some other software analyzes video frames. Further, in the method of the present invention spatial high-frequency intensities with straight shapes are analysed by said DVB-H software or some other software.

It is also conceivable that in the method of the present invention after spatial high-frequency intensities with straight shapes are analysed corresponding information is input to a pop-up software. Further said information is processed in a video decoder. But said information can also be processed in a video codec.

It has further to be noted that said subtitles/text are recognized by said DVB-H software and said subtitles/text are dynamic or fixed on said display 200. In the method of the present invention said DVB-H software or some other software analyzes video frames to find textual content if said subtitles/text are fixed. Also a video decoder can be used for determining the location of said pop-up window 10 on said display 200.

Said method for dynamically positioning of pop-up windows can also use motion vectors of macro-blocks, whereby with said motion vectors it is possible to estimate which 16×16 blocks of a video content on said display 200 have moved and in which direction they have moved.

It should be further noted that said pop-up window 10 is covering said area of changing pixels which are strongly changing, wherein said fixed area is not covered if a portion of said video frame is fixed and a background on said display 200 is changing. It has also to be noted that if a small portion of said video frame is changing while the rest of the frame is almost fixed said pop-up window 10 covers said portion which is fixed. It can also be understood that said video frames are updated by a window server. Video frames can also be updated by a display driver.

It is also conceivable that said pop-up window 10 is displayed partly transparent. Further has to be noted that said changing pixels are changing pixels of a displayed DVB-H stream and said analyzing of face shaped structures in said changing pixels is executed by a specific algorithm. Further it has to be noted that an algorithm is analyzing face shaped structures in said changing pixels.

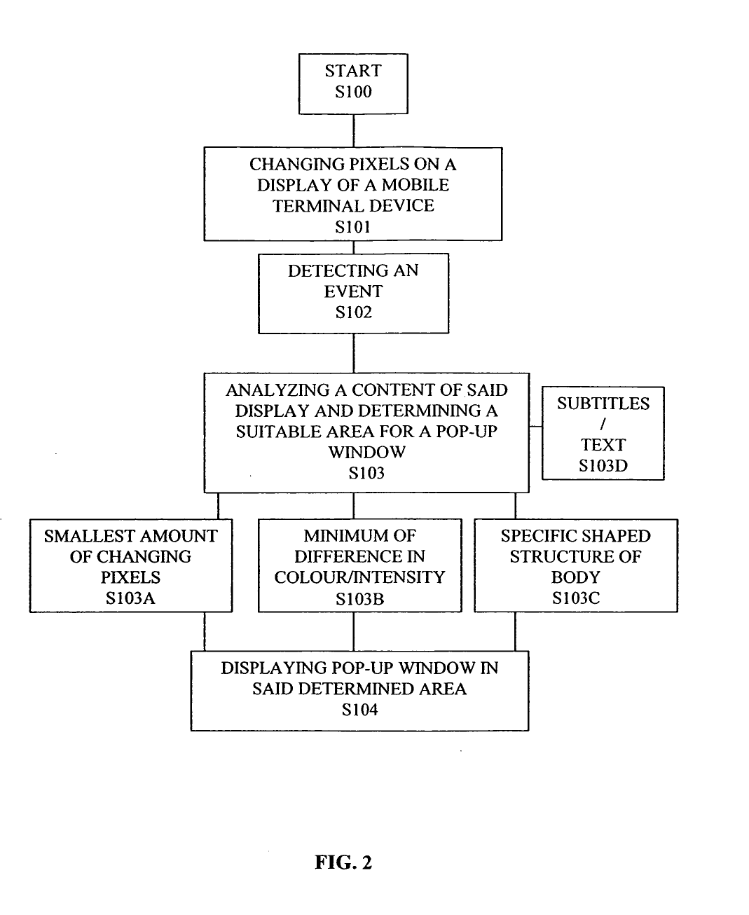

With reference to FIG. 2 it is illustrated a block diagram of the methodical steps of dynamically positioning of a pop-up window 10, whereby said determined area, which does not interfere with said content of said display is defined by the analyzing steps of the smallest amount of changing pixels, step S103A, the minimum of difference in colour and/or intensity, step S103B and a specific shaped structure of a human body, which is stationary for a predetermined period of time, step S103C and subtitles/text, step S103D.

Thereby the methodical steps for a dynamically positioning of a pop-up window 10 in a display 200 of a mobile terminal device 100 are shown, said display 200 showing changing pixels, wherein said mobile terminal device 100 is detecting an event to trigger appearance of said pop-up window 10 on said display 200, wherein there is conducted an analyzing step to determine an area characterized by at least one of the following features: the smallest amount of changing pixels for a predetermined period of time, step S103A; and/or a minimum of difference in colour and/or intensity between the pixels of said area, step S103B; and/or a specific shaped structure of a human body which is stationary for a predetermined period of time, step S103C and/or subtitles/text, step S103D.

The step S103A of determining the smallest amount of changing pixels for a predetermined period of time is thereby obtained by monitoring said changing pixels over a predetermined amount of time and by comparing with the amount of changing. The area obtained with the smallest amount of changing pixels defines then the place for positioning said pop-up window.

Also the step S103B of determining a minimum of difference in colour and/or intensity between the pixels is thereby obtained by monitoring said changing pixels over a predetermined amount of time and by comparing with the amount of changing. The area obtained with the minimum of difference in colour and/or intensity between the pixels of said area defines then the place for positioning said pop-up window.

Also the step S103C of determining a specific shaped structure of a human body which is stationary for a predetermined period of time is thereby obtained by monitoring said changing pixels over a predetermined amount of time and by comparing with the amount of changing with a specific analysing software. The area obtained for a wished specific shaped structure of a human body defines then the place for positioning said pop-up window.

Also the step S103D of determining subtitles/text, which can be stationary or dynamic for a predetermined period of time is thereby obtained by monitoring said changing pixels over a predetermined amount of time and by comparing with the amount of changing with a specific analysing software. The determined area, which interferes minimally with said subtitles/text defines then the place for positioning said pop-up window.

It is also conceivable that all four steps S103A-S103D are executed. Either they are executed consecutive or in another sequence.

It is also conceivable that some steps are executed for several times, what is depending upon the specific features of the used film, etc.

As in FIG. 1, in step S100 the mobile terminal device 100 is started by a user, so the user is switching on said mobile terminal device 100. The mobile terminal device 100 can be a mobile TV phone. So the user can watch TV and also receive or execute calls.

While the mobile terminal device 100 is running and a user is watching TV or something other on said display 200 of said mobile terminal device 100 there are changing pixels on said display 200 of said mobile terminal device 100, as during a film the pixels change their colour and/or intensity.

In a further step S102 said mobile terminal device 100 is detecting an event 102. Said event can be an incoming message, e.g. a SMS, a message that said user received an e-mail, etc.

In a further step 103 in said method an area is determined, which does not interfere with said content of said display, as has been described in FIG. 1.

However in comparison to FIG. 1 at least one of the steps S103A, S103B, S103C or 103D can be executed.

So, either the smallest amount of changing pixels for a predetermined period of time S103A; and/or a minimum of difference in colour and/or intensity between the pixels of said area can be determined S103B; and/or a specific shaped structure of a human body can be determined S103C, which is stationary for a predetermined period of time and/or subtitles/text, step 103D, which are stationary or dynamic for a predetermined period of time are determined.

Finally after said area which does not interfere with said content of said display is determined a pop-up window 10 with said message is displayed in said determined area in step S104.

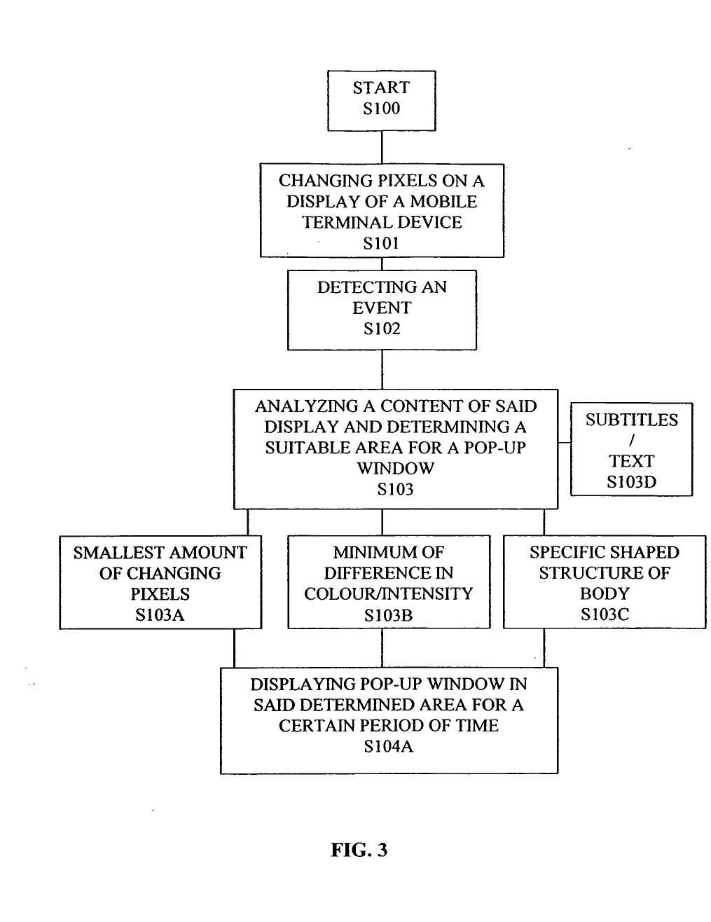

With reference to FIG. 3 it is illustrated a block diagram of the methodical steps of dynamically positioning of a pop-up window 10, whereby said area, which does not interfere with said content of said display is defined by the analyzing steps of the smallest amount of changing pixels, step S103A, the minimum of difference in colour and/or intensity, step S103B and a specific shaped structure of a human body, which is stationary for a predetermined period of time, step S103C, and/or subtitles/text, step 103D, whereby said pop-up window 10 in said determined area is displayed for a certain period of time S104A, whereby said period of time depends upon a deviation from a predetermined value from said smallest amount of changing pixels and/or from said minimum of difference in colour and/or intensity between the pixels of said area and/or from said specific shaped structure of a human body.

As in FIGS. 1 and 2, in step S100 the mobile terminal device 100 is started by a user, so the user is switching on said mobile terminal device 100. The mobile terminal device 100 can be a mobile TV phone. So the user can watch TV and also receive or execute calls. While the mobile terminal device 100 is running and a user is watching TV or something other on said display 200 of said mobile terminal device 100 there are changing pixels on said display 200 of said mobile terminal device 100, as during a film the pixels change their colour and/or intensity.

In a further step S102 said mobile terminal device 100 is detecting an event 102. Said event can be an incoming message, e.g. a SMS, a message that said user received an e-mail, etc.

In a further step 103 in said method an area is determined, which does not interfere with said content of said display as has been described in FIG. 1.

Further at least one of the steps S103A, S103B, S103C or 103D can be executed. So, either the smallest amount of changing pixels for a predetermined period of time S103A; and/or a minimum of difference in colour and/or intensity between the pixels of said area can be determined S103B; and/or a specific shaped structure of a human body can be determined S103C, which is stationary for a predetermined period of time and/or subtitles/text can be determined.

Finally after said which does not interfere with said content of said display is determined a pop-up window 10 with said message is displayed in said determined area in step S104, whereby said pop-up window 10 in said determined area is displayed for a certain period of time S104A, whereby said period of time depends upon a deviation from a predetermined value from said smallest amount of changing pixels and/or from said minimum of difference in colour and/or intensity between the pixels of said area and/or from said specific shaped structure of a human body.

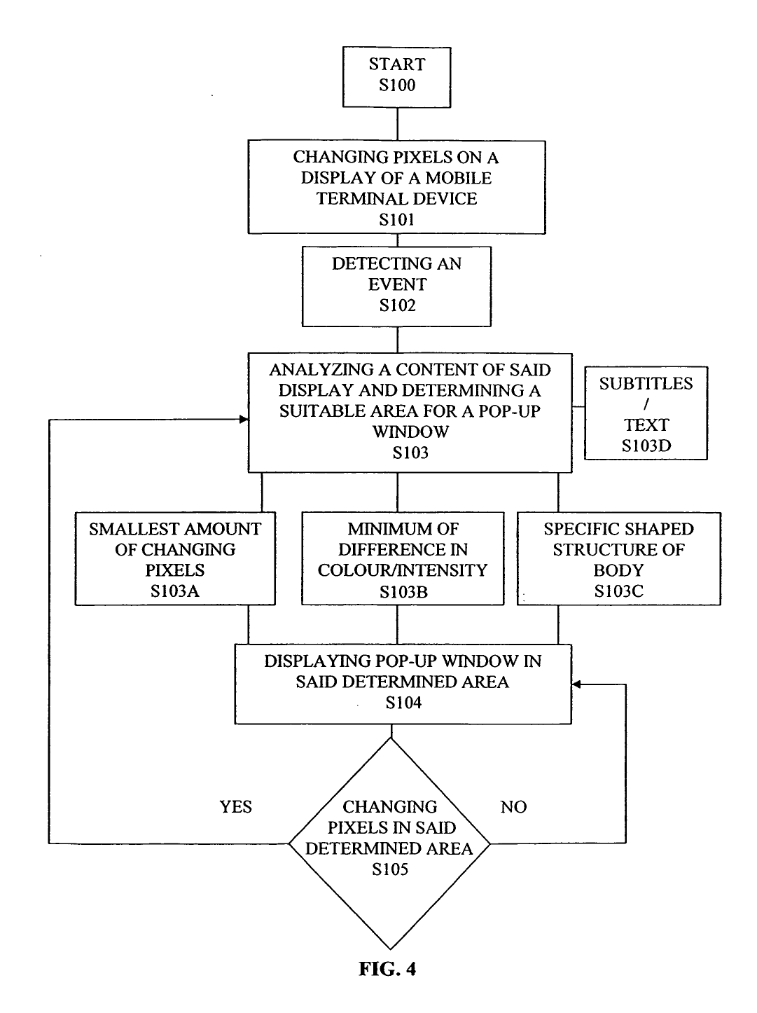

With reference to FIG. 4 it is illustrated a block diagram of the methodical steps of dynamically positioning of a pop-up window 10, whereby the steps S103A, S103B, 103C and/or S103D are repeated, if the pixels are changing in said determined area, step S105, and a said pop-up window 10 is displayed in a new determined area on said display 200, whereby the new determined area can differ from the previous determined area. Step S105 can be repeated as long as area, which does not interfere with said content of said display is determined with at least one of said steps S103A, S103B, S103C and/or S103D.

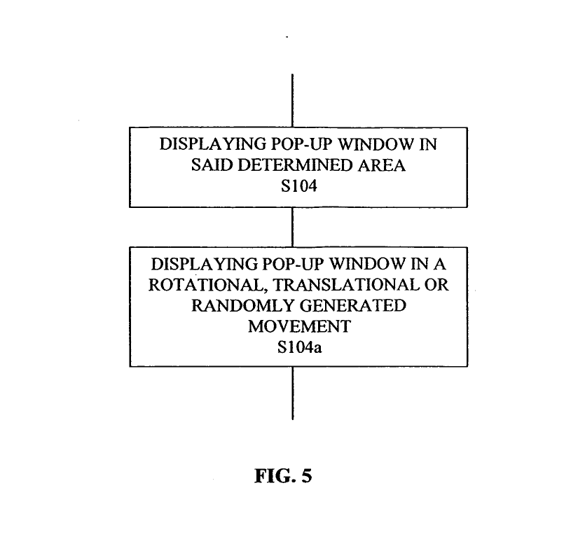

Further, in FIG. 5 it is partly illustrated that a pop-up window 10 can be displayed in a rotational, translational or any randomly generated movement S104a. It is also conceivable, that the pop-up window 10 executes other movements, which are user-configurable.

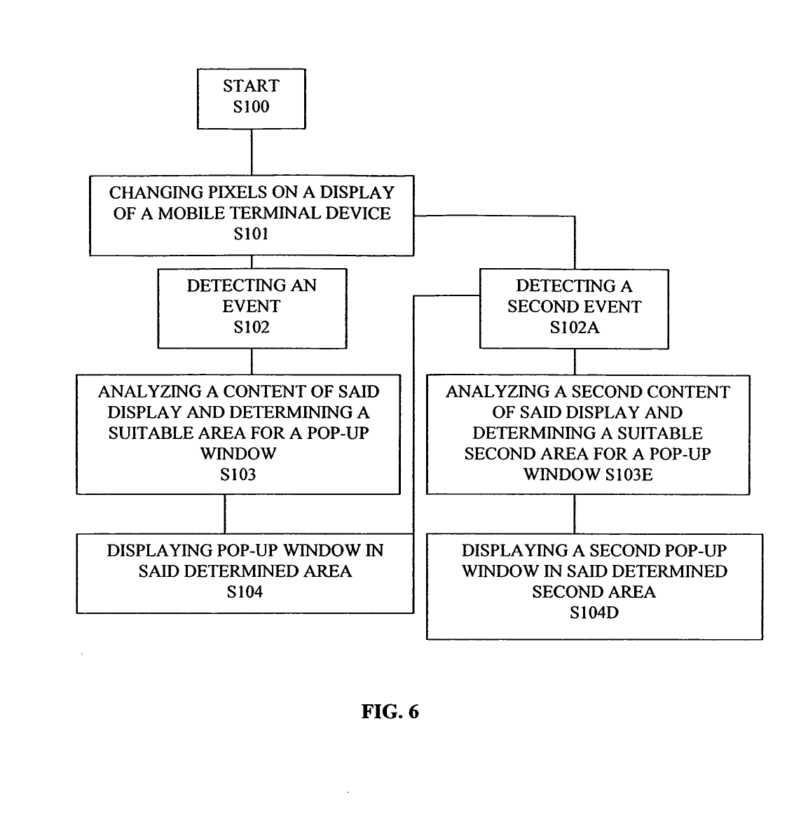

Further, FIG. 6 illustrates in step S102 the detecting of a second event, e.g. of a second incoming message. Afterwards follow the steps S103E and S104D, whereby the steps 103E and S104D are equal to said previous described steps S103 and S104 in FIG. 1.

It is also conceivable that several different events are received and displayed by a mobile terminal device 100, so several independent steps of analyzing an area where said pop-up window can be positioned with minimum interference with said content can be executed with said method of the present invention.

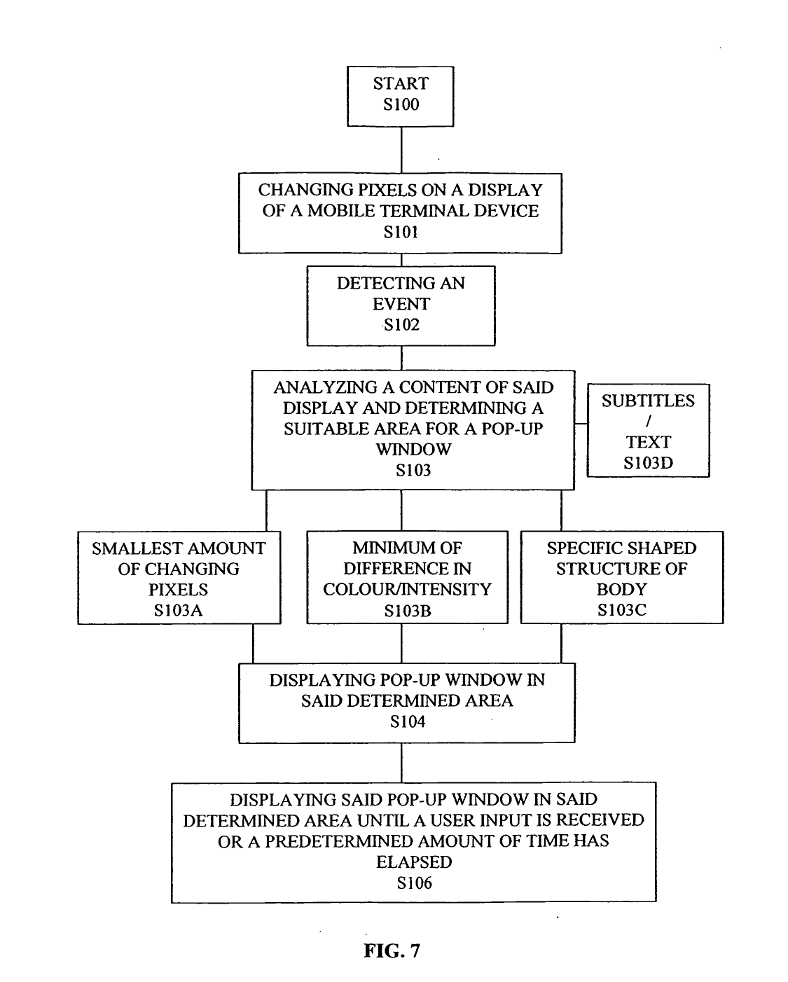

Further FIG. 7 additionally shows the methodical step S106, whereby said pop-up window 10 is displayed in said determined area until a user input is received or a predetermined amount of time has elapsed. The input of said user can thereby be user-configurable, what means that e.g. after pressing a specific key on a keyboard or key-pad of said mobile terminal device said pop-up window will not be displayed any longer on said display.

It is also conceivable that the user intends to program a certain predetermined amount of time after which said pop-up window disappears from said display of said mobile terminal device. So, if the user does not want to any longer see said pop-up window 10, he/she can remove said pop-up window 10 via a predetermined input on a keyboard or directly on the display 200, e.g. via a touch-screen display.

It is also conceivable that the pop-up window 10 automatically is removed by a computer program product, e.g. a software, which is running on said mobile terminal device 100, after a predetermined time, whereby said user can determine the time after which said pop-up window removal is triggered.

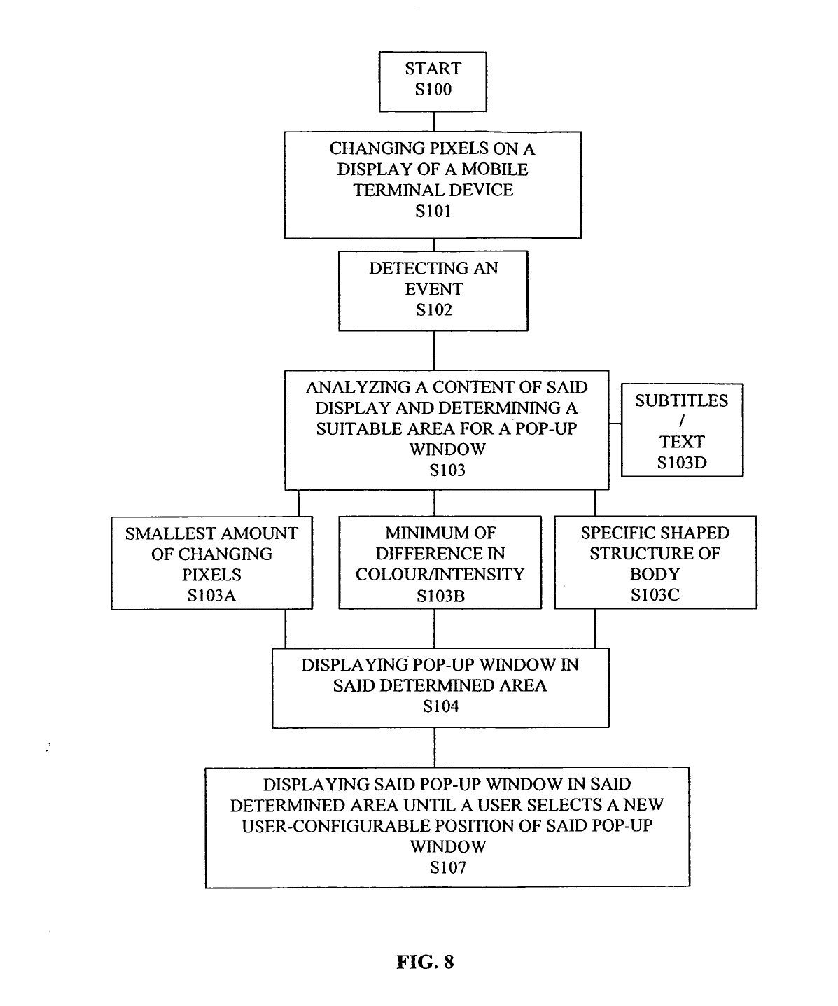

In comparison to FIG. 7, FIG. 8 shows in step S107 a displaying of said pop-up window 10 in said determined area until a user selects a new user-configurable position of said pop-up window 10. So, if said user wishes another position of said pop-up window 10 on said display 200, he/she can put said pop-up window 10 to another position on said display 200. Either, via a keyboard, a mouse or via a touch-screen display.

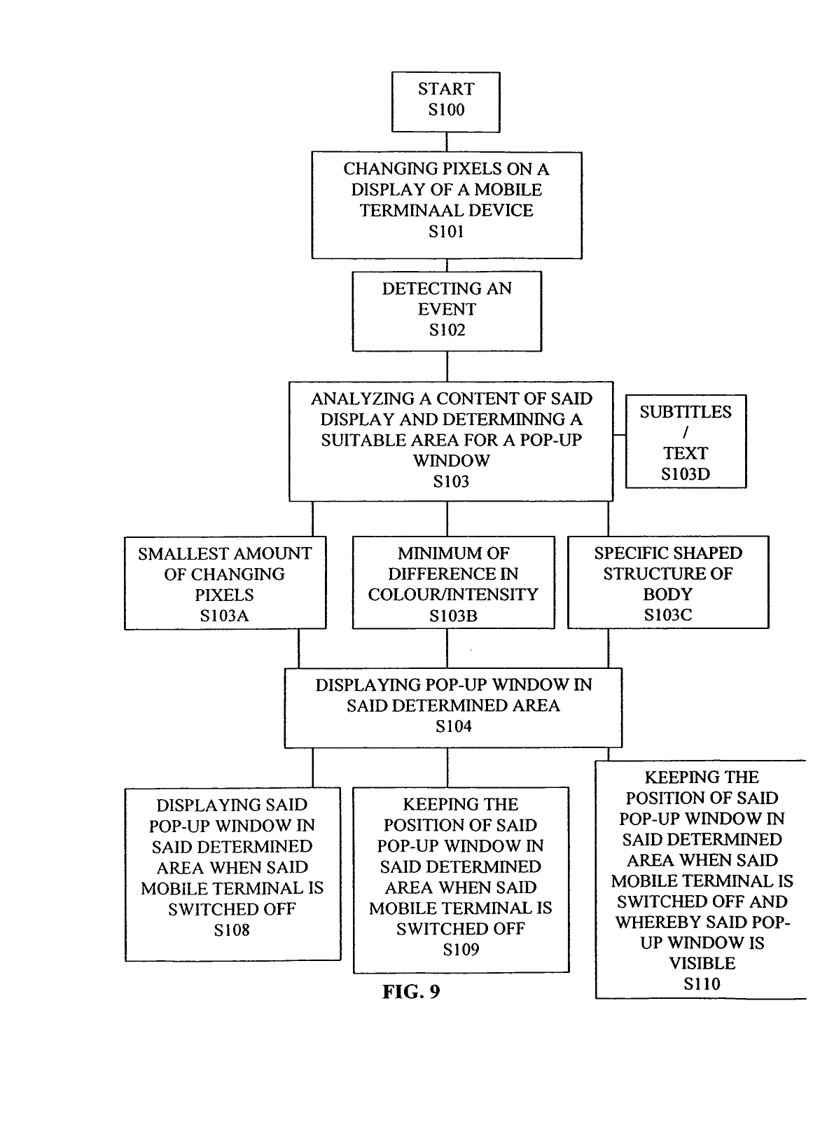

In a further embodiment of the present invention there are illustrated in steps S108-S110 of FIG. 9 three different possibilities of displaying said pop-up window 10 in said determined area.

Thereby, in step S108 said pop-up window 10 can further be displayed in said determined area when said mobile terminal device 100 is switched off by said user. So, the user can afterwards see said pop-up window on said display if he/she has forgotten to read said pop-up window with said message while the display was on. Thereby it is user-configurable if the user wants this additional service on his/her mobile terminal device.

Further in step S109 the position of said pop-up window 10 can be kept in said determined area, when said mobile terminal is switched off. So, the user can afterwards see said pop-up window on said display if he/she want to later read said pop-up window with said message on the display when he/she later is e.g. watching a film, etc. Thereby it is user-configurable if the user wants this additional service on his/her mobile terminal device.

In step S110 it is also conceivable that said pop-up window 10 still is visible when said mobile terminal device 100 is switched off, whereby said pop-up window 10 is keeping its position in said determined area. This is an additional possibility for the user to keep the position of said pop-up window on said display if it he/she aims for this service.

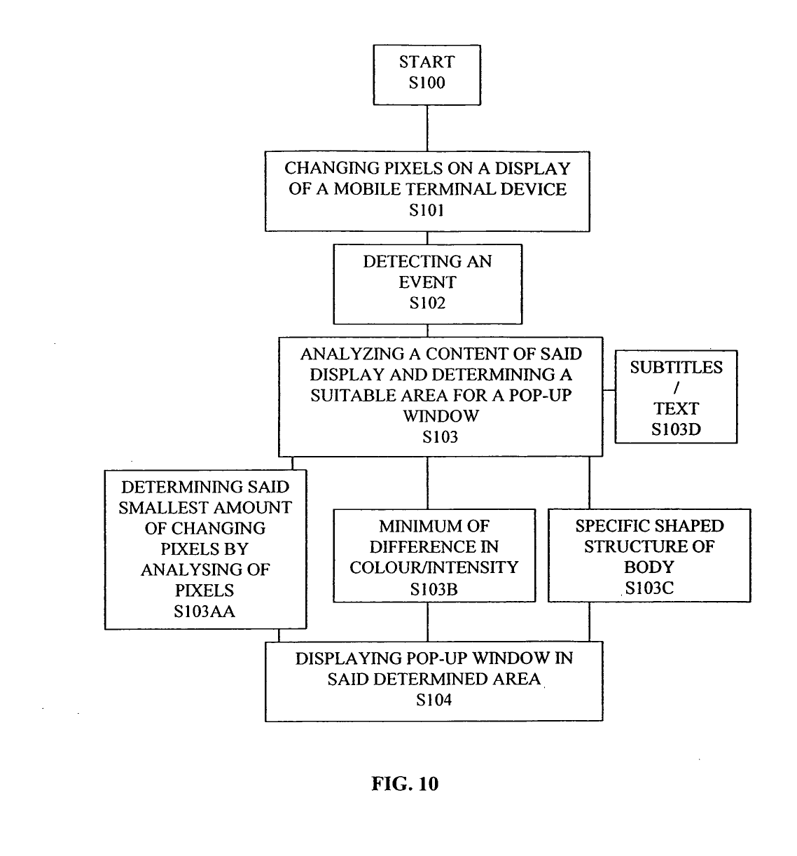

FIG. 10 shows in step S103AA that said step of determining said smallest amount of changing pixels is determined by an analysing of pixels. The analysing said amount of changing pixels is thereby executed by a specific software, which can be user-configurable, whereby there is monitored the amount of changing pixels and later compared with changes of said changing pixels.

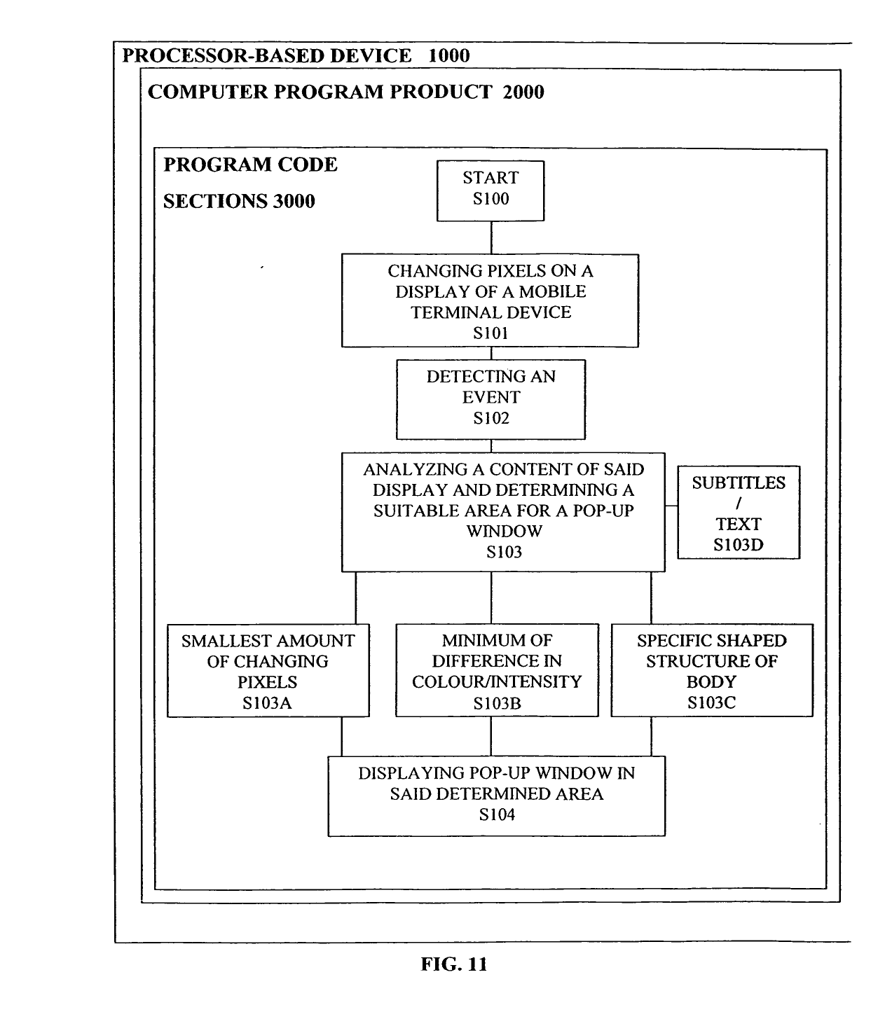

FIG. 11 illustrates a computer program product 2000, which is operative on a processor-based device 1000, e.g. said mobile terminal device 100, wherein said computer program product 2000 comprises program code sections 3000, which execute said described method with said steps S100 to S104 and wherein program code sections are stored on a machine-readable medium.

Said computer program product, comprises program code sections for carrying out operations, when said program is run on a processor-based device, a terminal device, a mobile terminal device 100, a network device, a portable terminal device, a consumer electronic device, or a mobile communication enabled terminal device, wherein a method for dynamically positioning of a pop-up window 10 in a display 200 of a mobile terminal device 100 is used, said display 200 showing changing pixels, wherein said mobile terminal device 100 is detecting an event to trigger appearance of said pop-up window 10 on said display 200, wherein said method is comprising a analyzing of an area on said display 200, said area, which does not interfere with said content of said display and displaying said pop-up window 10 in said determined area.

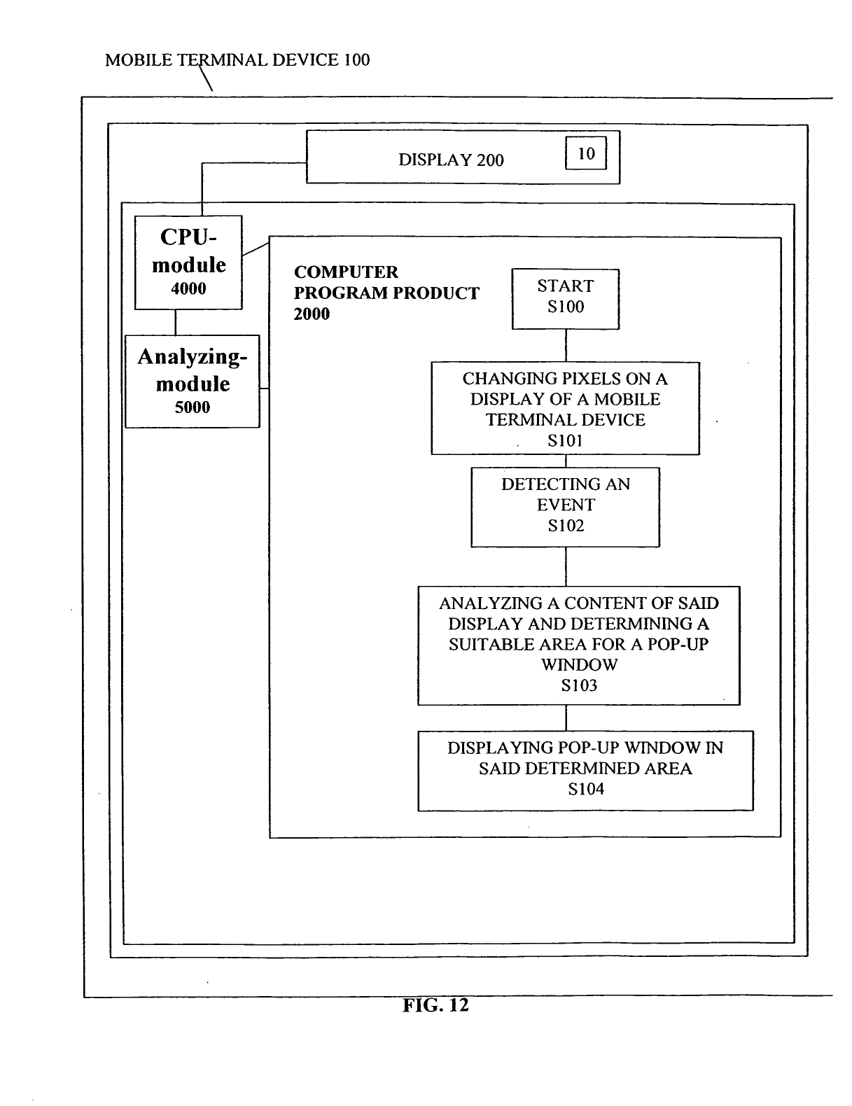

In FIG. 12 said mobile terminal device 100 is illustrated, which comprises a display 200 a CPU-module and a analyzing-module 5000, whereby said display 200, said CPU-module 4000 and said module for analyzing 5000 of said mobile terminal device 100 are connected with each other and whereby said CPU-module 4000 and said module for analyzing 5000 is connected with a computer program product 2000, whereby said CPU-module 4000 is configured to execute said computer program product 2000, which comprises methodical steps S100 to S104 as already described above in FIG. 1 to FIG. 11.

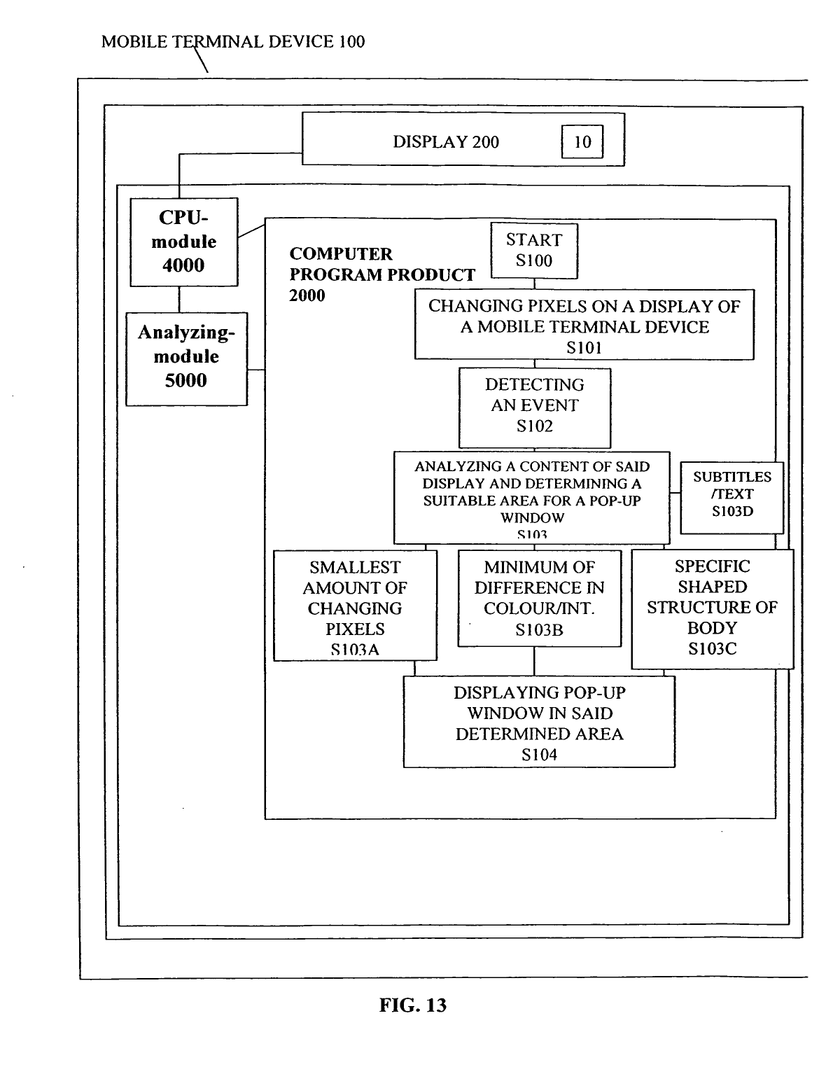

Finally, in FIG. 13 is illustrated said mobile terminal device 100, which comprises a display 200, a CPU-module 4000 and a module for analyzing 5000, whereby said display 200, said CPU-module 4000 and said module for analyzing 5000 of said mobile terminal device 100 are connected with each other and whereby said CPU-module 4000 and said module for analyzing 5000 is connected with a computer program product 2000, whereby said CPU-module 4000 is configured to execute said computer program product 2000, which comprises methodical steps S100 to S104 with detailed steps S103A to S103D as already described above in FIG. 1 to FIG. 11.

Further it is noted that said mobile terminal device 100 for dynamically positioning of a pop-up window 10 in a display 200 of a mobile terminal device 100, wherein said mobile terminal device 100 comprises a display 200, a CPU-module 4000 and a module for analyzing 5000 and wherein said display 200 is showing pixels, wherein said mobile terminal device 100 is detecting an event to trigger appearance of said pop-up window 10 on said display 200, comprises a module for analyzing 5000, being configured for analyzing said display 200, having said smallest amount of changing pixels of said area for a predetermined period of time; and/or having a minimum of difference in colour and/or intensity between the pixels of said area; and/or having a specific part of a human body for a predetermined period of time; and/or having subtitles/text and wherein said CPU-module being configured for displaying said pop-up window 10 in said determined area after said detection on said display 200.

Further it is noted that said device is a mobile TV phone and said device comprises a video decoder, which is connected to said CPU-module, said module for analyzing 5000 and said display 200 and wherein said video decoder being configured for determining the location of said pop-up window 10 on said display 200.

Further it is noted that said device comprises a window server, which is connected to said CPU-module 4000, said module for analyzing 5000 and said display 200 and wherein said window server being configured for updating video frames.

Further it is noted that said device comprises a display driver, which is connected to said CPU-module and said display 200 and wherein said display driver being configured for updating video frames.

It is will be evident for those skilled in the art that as the technology advances, the inventive concept can be implemented in a broad number of ways. The invention and its embodiments are thus not limited to the examples and specific embodiments described above but may vary within the scope of the claims.

1. A method comprising dynamically positioning of a pop-up window in a display of a mobile terminal device, said display showing changing pixels, wherein said mobile terminal device is for detecting an event to trigger appearance of said pop-up window on said display, said method further comprising:
analyzing a content of said display; and
determining a suitable area for said pop-up window, where said pop-up window can be positioned with minimum interference with said content.

2. A method comprising dynamically positioning of a pop-up window in a display of a mobile terminal device, said display showing changing pixels, wherein said mobile terminal device is for detecting an event to trigger appearance of said pop-up window on said display, wherein there is conducted an analyzing step to determine a suitable area, wherein said area comprises at least one of the following features:
the smallest amount of changing pixels for a predetermined period of time;
a minimum of difference in colour and/or intensity between the pixels of said area;
a specific shaped structure of a human body which is stationary for a predetermined period of time;
subtitles/text.

3. The method according to claim 1, wherein said pop-up window is displayed for a certain period of time in said determined area after said detection.

4. The method according to claim 1, wherein said pop-up window is displayed transparently.

5. The method according to claim 1, wherein said step of analyzing is repeated in case the area in which the pop-up window is placed is affected by changing pixels.

6. The method according to claim 1, wherein a size of said pop-up window is related to the size of said determined area and changes dynamically therewith.

7. The method according to claim 1, wherein a position of said pop-up window is dependent on a position of said determined area and dynamically changes therewith.

8. The method according to claim 1, wherein said pop-up window does a rotational, translational or any randomly generated movement on said display.

9. The method according to claim 1, wherein said event is a receipt of a message.

10. The method according to claim 1, wherein a first pop-up window appears on said display upon triggering receipt of a message and whereby a further pop-up window appears on said display when a further message is received by said mobile terminal device.

11. The method according to claim 1, wherein said pop-up window is removed from said display after a predetermined amount of time has elapsed or a user input is received.

12. The method according to claim 1 wherein said pop-up window is keeping its originally determined position until a user selects a new user-configurable position of said pop-up window on said display.

13. The method according to claim 1, wherein said pop-up window keeps its position on said display, when said mobile terminal device is switched off.

14. The method according to claim 1, wherein said pop-up window keeps its position and still is visible on said display, when the display is switched off.

15. The method according to claim 1, wherein after said pop-up window appears for the first time on said display, when the mobile terminal device is switched on, a specific sound is actuated, said sound being user-configurable.

16. The method according to claim 1, wherein a user can switch on or off said method, when the mobile terminal device is operating.

17. The method according to claim 2, wherein said smallest amount of changing pixels is determined by analyzing of pixels on said display.

18. The method according to claim 1, wherein said mobile terminal device is a mobile TV phone.

19. The method according to claim 2, wherein said pop-up window is positioned in an area on the display on top of said subtitles/text, whereby said pop-up window does not cover said subtitles/text.

20. The method according to claim 2, wherein a position of said subtitles/text is recognized by a DVB-H software.

21. The method according to claim 20, wherein said DVB-H software will input corresponding information for a pop-up software if said DVB-H software is for rendering said subtitles/text.

22. The method according to claim 20, wherein said DVB-H software or some other software analyzes video frames.

23. The method according to claim 20, wherein spatial high-frequency intensities with straight shapes are analyzed by said DVB-H software or some other software.

24. The method according to claim 23, wherein after spatial high-frequency intensities with straight shapes are analysed corresponding information is input to a pop-up software.

25. The method according to claim 24, wherein said information is processed in a video decoder.

26. The method according to claim 24, wherein said information is processed in a video codec.

27. The method according to claim 20, wherein said DVB-H software is for recognizing said subtitles/text.

28. The method according to claim 19, wherein said display is for displaying said subtitles /text dynamically or fixed on said display.

29. The method according to claim 20, wherein said DVB-H software or some other software analyzes video frames to find textual content if said subtitles/text is fixed.

30. The method according to claim 25, wherein said video decoder is used for determining location of said pop-up window on said display.

31. The method according to claim 1, wherein said method uses motion vectors of macro-blocks.

32. The method according to claim 31, wherein with said motion vectors it is possible to estimate which 16×16 blocks of a video content on said display have moved and in which direction.

33. The method according to claim 22, wherein said pop-up window is covering an area of changing pixels which is strongly changing, wherein a fixed area is not covered if a portion of said video frames is fixed and a background on said display is changing.

34. The method according to claim 22, wherein if a small portion of a video frame is changing while the rest of the frame is almost fixed said pop-up window covers said portion which is almost fixed.

35. The method according to claim 22, wherein if most of a video frame is changing while the rest of the frame is almost fixed said pop-up window covers said portion which is fixed.

36. The method according to claim 22, wherein said video frames are updated by a window server.

37. The method according to claim 22, wherein said video frames are updated by a display driver.

38. The method according to claim 2, wherein said pop-up window is displayed partly transparently.

39. The method according to claim 1, wherein said changing pixels are changing pixels of a displayed DVB-H stream.

40. The method according to claim 1, wherein said analyzing is for analyzing of face shaped structures in said changing pixels and is executed by an algorithm.

41. The method according to claim 2, wherein an algorithm for analyzing face shaped structures in said changing pixels is provided for said analyzing steps.

42. The method according to claim 1, wherein an algorithm for analyzing face shaped structures in said changing pixels is provided for said analyzing step.

43. A computer program product, comprising program code sections for carrying out operations, when said program is run on a processor-based device, a terminal device, a mobile terminal device, a network device, a portable terminal device, a consumer electronic device, or a mobile communication enabled terminal device, wherein a method for dynamically positioning of a pop-up window in a display of a mobile terminal device is used, said display showing changing pixels, wherein said mobile terminal device is for detecting an event to trigger appearance of said pop-up window on said display, said method comprising:
analyzing content of said display; and
determining a suitable area for said pop-up window, where said pop-up window can be positioned with minimum interference with said content.

44. The computer program product according to claim 43, wherein program code sections are stored on a machine-readable medium.

45. A mobile terminal device for dynamically positioning of a pop-up window in a display of a mobile terminal device, wherein said mobile terminal device comprises a display and a CPU-module and wherein said display is for showing pixels, wherein said mobile terminal device is for detecting an event to trigger appearance of said pop-up window on said display, comprising:
a module for analyzing content of said display; and
a module for determining a suitable area for said pop-up window, where said pop-up window can be positioned with minimum interference with said content.

46. The mobile terminal device according to claim 45, wherein the module for analyzing is configured for analyzing an area on said display, said area having
a smallest amount of changing pixels of said area for a predetermined period of time;
a minimum of difference in colour and/or intensity between the pixels of said area;
a specific part of a human body for a predetermined period of time;
subtitles/text;
and said CPU-module being configured for
displaying said pop-up window in said suitable area on said display as determined by said module for determining said suitable area.

47. The device according to claim 45, wherein said device is a mobile TV phone.

48. The device according to claim 45, wherein said device comprises a video decoder, which is connected to said display and said CPU-module, said video decoder configured for determining a location of said pop-up window on said display.

49. The device according to claim 45, wherein said device comprises a window server, which is connected to said display and said CPU-module, said window server configured for updating video frames.

50. The device according to claim 45, wherein said device comprises a display driver, which is connected to said display and said CPU-module, said display driver configured for updating video frames.
